(19) United States
(12) Patent Application Publication
(10) Pub. No.: US 2014/0237427 A1
(43) Pub. Date: Aug. 21, 2014

(54) BROWSING DEVICE, BROWSING SYSTEM, AND NON-TRANSITORY COMPUTER READABLE MEDIUM

(71) Applicant: FUJI XEROX CO., LTD., Tokyo (JP)

(72) Inventors: Shinobu OZEKI, Kanagawa (JP); Kazuhiro HAYASHI, Kanagawa (JP); Akira TATEISHI, Kanagawa (JP); Masaru KIJIMA, Kanagawa (JP); Motoki TANIGUCHI, Kanagawa (JP); Eisaku HAYASHI, Kanagawa (JP)

(73) Assignee: FUJI XEROX CO., LTD., Tokyo (JP)

(21) Appl. No.: 14/016,688

(22) Filed: Sep. 3, 2013

(30) Foreign Application Priority Data
Feb. 20, 2013 (JP) 2013-031324

(51) Int. Cl. G06F 3/0484

(52) U.S. Cl. CPC G06F 3/0484
USPC 715/811

(57) ABSTRACT

Provided is a browsing device including a display unit that displays a content, an operation receiving unit that receives a user's operation, a history extraction unit that extracts an operation history regarding an operation that does not change the display of the content displayed on the display unit, and a calculation unit that calculates an interest level of the user with respect to the content, based on the operation history extracted by the history extraction unit.

### CROSS-REFERENCE TO RELATED APPLICATIONS

This application is based on and claims priority under 35 USC 119 from Japanese Patent Application No. 2013-031324 filed Feb. 20, 2013.

### BACKGROUND

### Technical Field

The present invention relates to a browsing device, a browsing system, and a non-transitory computer readable medium.

### SUMMARY

According to an aspect of the invention, there is provided a browsing device including: a display unit that displays a content; an operation receiving unit that receives a user's operation; a history extraction unit that extracts an operation history regarding an operation that does not change the display of the content displayed on the display unit; and a calculation unit that calculates an interest level of the user with respect to the content, based on the operation history extracted by the history extraction unit.

### BRIEF DESCRIPTION OF THE DRAWINGS

Exemplary embodiments of the present invention will be described in detail based on the following figures, wherein:

FIG. 1 is a diagram illustrating a hardware configuration of a browsing device according to a first exemplary embodiment;

FIG. 2 is a block diagram illustrating a browsing program executed in the browsing device according to the first exemplary embodiment;

FIGS. 3A to 3D are diagrams exemplifying various types of information processed by the browsing program illustrated in FIG. 2;

FIGS. 4A to 4C are diagrams exemplifying operation screens displayed on a UI device by an interest level calculation instruction unit;

FIGS. 5A and 5B are diagrams exemplifying operation screens displayed on the UI device by an interest level calculation instruction unit;

FIGS. 6A to 6C are diagrams exemplifying interest levels displayed on the UI device by an interest level display unit;

FIG. 7 is a diagram illustrating a browsing system according to a second exemplary embodiment;

FIG. 8 is a block diagram illustrating a browsing program executed in the browsing device according to the second exemplary embodiment; and

FIG. 9 is a block diagram illustrating a browsing history management device program executed in a browsing history management device according to the second exemplary embodiment.

### DETAILED DESCRIPTION

### First Exemplary Embodiment

First, a first exemplary embodiment will be described.

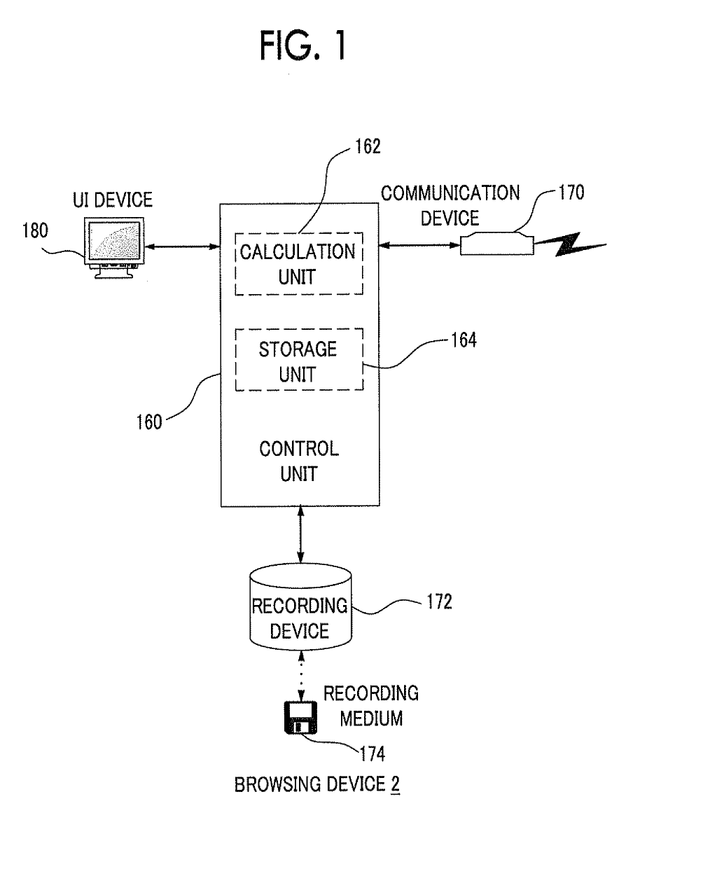

FIG. 1 is a diagram illustrating a hardware configuration of a browsing device 2 according to a first exemplary embodiment.

As illustrated in FIG. 1, the browsing device 2 is configured by a control unit 160 including a calculation unit 162 such as a CPU, a storage unit 164 such as a memory, and the like, a communication device 170 that performs a communication through a network, a recording device 172, a recording medium 174 such as a USE memory or an SD memory card, and a user interface device (UI device) 180.

That is, the browsing device 2 is an information processing device having hardware configuration components as a computer capable of communicating with information processing and other processing devices or terminals.

Further, in each of the following figures, the same reference numerals are given to the substantially same configuration components and processes.

The UI device 180 includes a display device such as a Graphical User Interface (GUI), a Liquid Crystal Display (LCD) display device or a Cathode Ray Tube (CRT) display device, a keyboard and a touch panel. In the following exemplary embodiments, as an example, the UI device 180 is described as a touch panel in which the display device and an input device are combined.

Further, each device in other exemplary embodiments described later has a hardware configuration illustrated in FIG. 1, and thus is the information processing device having hardware configuration components as the computer capable of communicating with the information processing and other processing devices or terminals.

The browsing device 2 performs a process that allows the user to browse a content of a document and the like.

In addition, an object of the user's browsing is a document in each of the following exemplary embodiments, but the object of the user's browsing is not limited to the document, but may be a content including documents, images, voices, videos, various types of information, and the like (the same is applied also to other exemplary embodiments).

Here, the content is various types of information being an object of the user's browsing. Further, the content is referred to as what is electronically created (digitized) obtained through various types of digitizing processes such as a scanning, a digitizing process, or the like, and what is already digitized.

For example, the content includes a document configured by characters and (still) images, images, voices, and videos containing moving images.

Further, the document includes what is printed on paper media, and digitized document files (document data). The voice includes what are recorded on a tape, digitized voice files, and the like. The video includes what is recorded on video tapes, digitized video files, and the like.

Further, data obtained by digitizing contents or data indicating already digitized contents may be referred to as content item data.

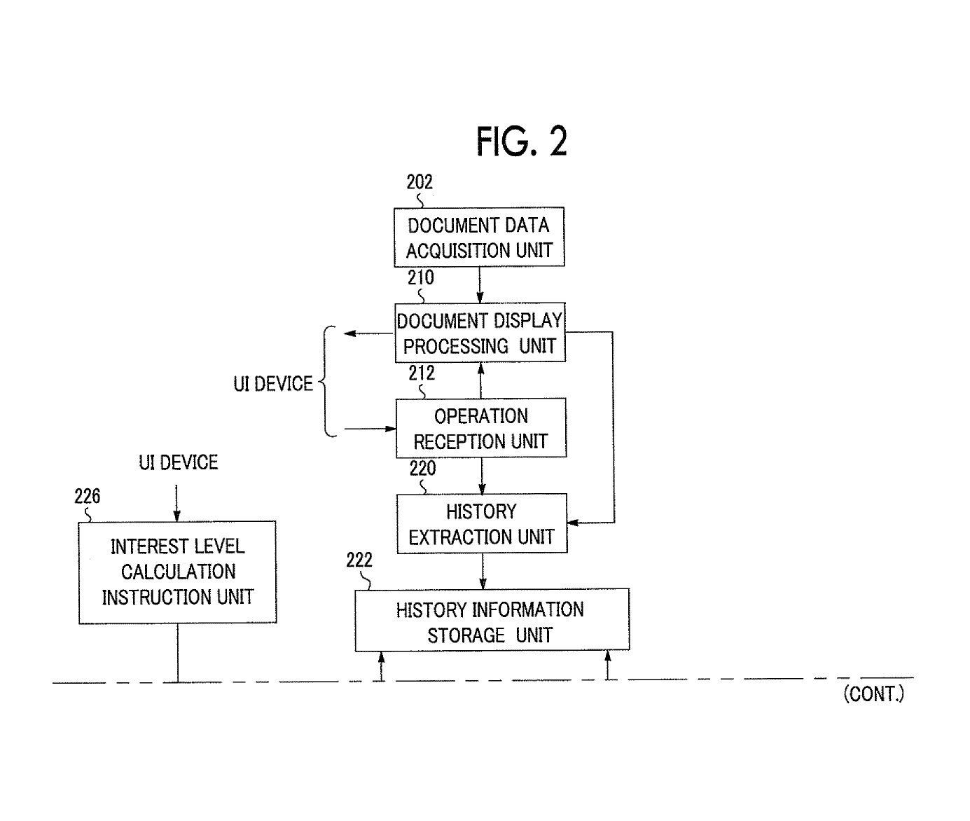

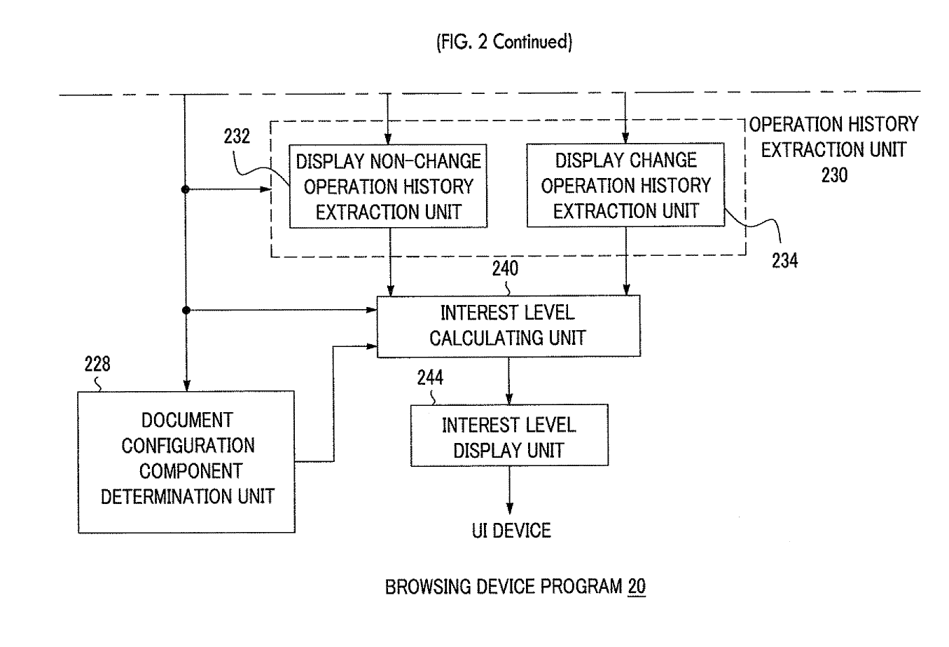

FIG. 2 is a block diagram illustrating a browsing program 20 executed in the browsing device 2 according to the first exemplary embodiment.

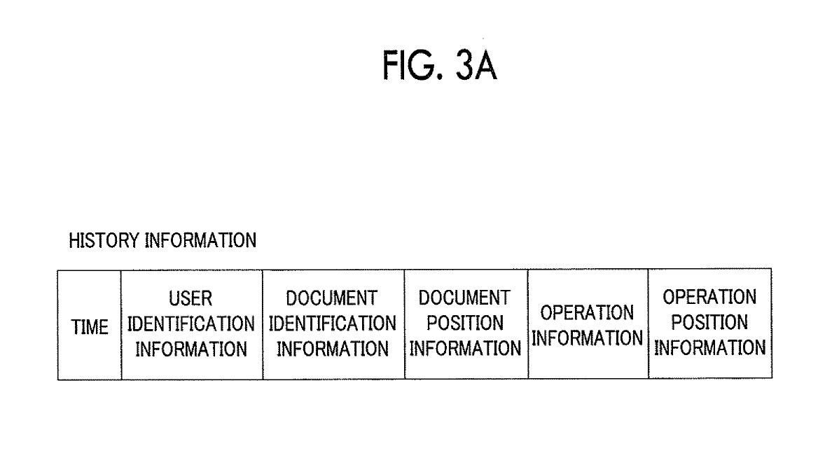

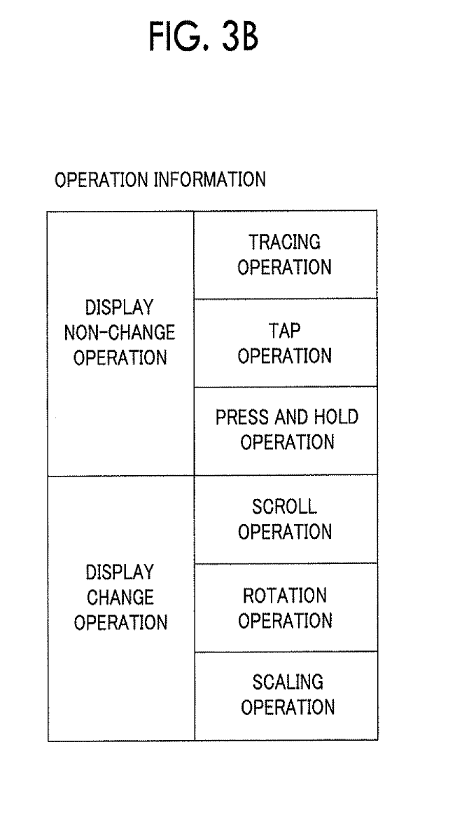

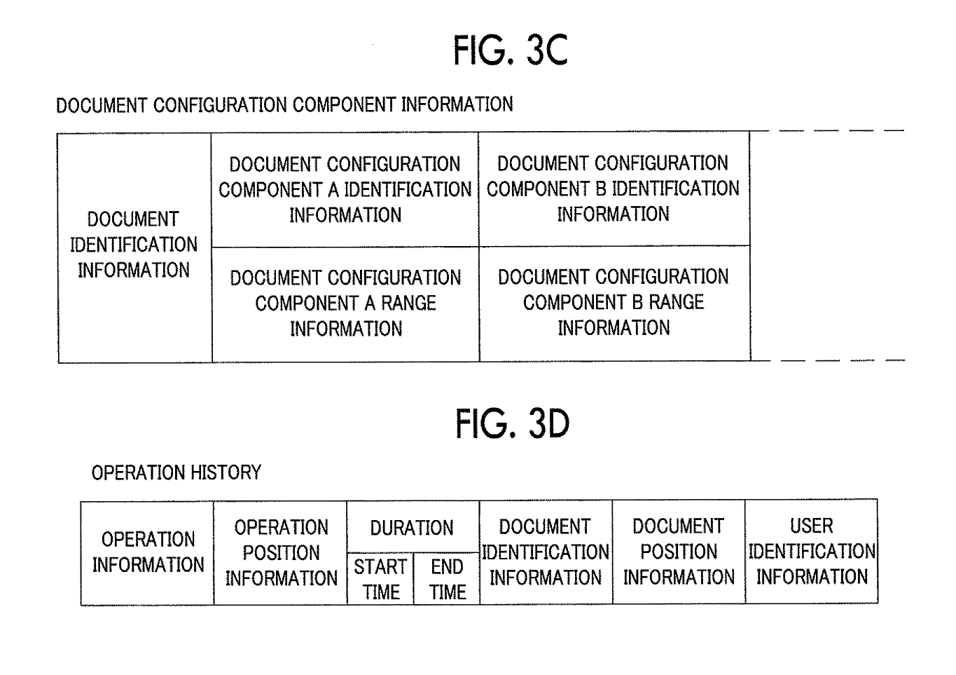

FIGS. 3A to 3D are diagrams exemplifying various types of information processed by the browsing program 20 illustrated in FIG. 2.

The browsing program 20 is supplied to the browsing device 2 through, for example, the recording medium 174 (FIG. 1) or the communication device 170. Then, the browsing program 20 is loaded on the storage unit 164, and executed specifically using hardware resources of the browsing device 2, on an OS (not shown) installed in the browsing device 2 (the same is applied also to other exemplary embodiments).

As illustrated in FIG. 2, the browsing program 20 is configured by a document data acquisition unit 202, a document display processing unit 210, an operation reception unit 212, a history extraction unit 220, a history information storage unit 222, an interest level calculation instruction unit 226, a document configuration component determination unit 228, an operation history extraction unit 230, an interest level calculating unit 240, and an interest level display unit 244.

Further, the operation history extraction unit 230 is configured by a display non-change operation history extraction unit 232, and a display change operation history extraction unit 234.

The document data acquisition unit 202 acquires document data indicating a document (content) that is the object of the user's browsing, and outputs the acquired document data to the document display processing unit 210.

Specifically, for example, the document data acquisition unit 202 acquires document data stored in the recording medium 174, document data by downloading the document data from a server (not shown) through a network, or document data obtained by a reading device's (not shown) reading of a document formed on a paper medium.

The document display processing unit 210 performs a process of causing document data to be displayed on the UI device 180 such as the touch panel.

The operation reception unit 212 receives information (operation information) indicating an operation that the user performs with respect to the UI device 180, and outputs the received information to the document display processing unit 210 (the operation information will be described later).

At this time, the operation reception unit 212 associates the operation information with a position of a document corresponding to the operation.

Specifically, in a case where the user performs an operation by contacting the UI device 180 such as the touch panel with a finger or a touch pen, the operation reception unit 212 determines which position in a document displayed on the UI device 180 the contacted position corresponds to.

The document display processing unit 210 changes a display, depending on operation information received from the operation reception unit 212.

Specifically, in a case where the user performs an operation to scroll a screen on which document data items are displayed, the document display processing unit 210 changes the position of the displayed document.

Further, in a case where the user performs an operation to enlarge (or reduce) the screen on which the document data items are displayed, the document display processing unit 210 displays the displayed document to be enlarged (or reduced).

On the other hand, in a case where the operation reception unit 212 receives a display non-change operation that will be described later, the document display processing unit 210 does not change the document display on the UI device 180 (that is, does not move or scale the document on the screen).

For example, at each time when the operation reception unit 212 receives an operation, or at a certain time interval, the history extraction unit 220 extracts history information from the document display processing unit 210 and the operation reception unit and stores the extracted history information in the history information storage unit 222.

FIG. 3A is a diagram exemplifying the history information.

The history information includes a time, user identification information of a user who is operating the browsing device 2 (or identification information of the browsing device 2), document identification information of the document browsed at that time, document position information indicating a position of a the document displayed on the UI device 180 at that time, operation information indicating an operation that the user performs with respect to the UI device 180 at the time, and operation position information indicating a position where the operation is performed.

The document position information is information indicating a range on the document displayed on the screen of the UI device 180 (that is, information indicating which range of the document is displayed), and includes, for example, a coordinate on the document corresponding to an upper left position and a coordinate on the document corresponding to a lower right position, of the screen of a rectangular shape.

In addition, in a case where the document is broken into each page, the document position information may include a page number of the page being displayed.

The operation position information includes, for example, a coordinate on a document corresponding to a position where a finger, a touch pen, or the like is in contact with the touch panel, in a state in which the document is displayed on the touch panel.

In addition, in a case where a document is broken into each page, the document position information and the operation position information may include the page number of the page being displayed.

FIG. 3B is a diagram exemplifying operation information.

The operation information is classified into a display non-change operation that does not change the display of the document displayed on the UI device 180 and a display change operation that changes the display of the document displayed on the UI device 180.

The display change operation is an operation to cause an area of the document being displayed on the UI device 180 to be changed to another area and to cause another area to be displayed, such as an operation to move the display of the document from a first chapter to a second chapter, and an operation to enlarge a certain area of the document.

The display change operation is, mainly, an operation that the user performs consciously.

For example, the display change operation includes a scroll operation, a rotation operation, and a scaling operation.

The scroll operation is an operation to vertically and horizontally move the document being displayed, and for example, is an operation (for example, slide) to vertically and horizontally move the document while a finger, a touch pen, or the like is in contact with the touch panel, an operation (for example, flick) to quickly move the document vertically and horizontally by quickly flicking the document after the finger, the touch pen, or the like is in contact with the touch panel, and an operation to change the page being displayed by operating a scroll bar displayed on the screen.

The rotation operation is an operation to rotate the document being displayed, and for example, is an operation to rotate the display by taking one finger as a center without moving the one finger and rotating the other finger, while two fingers are in contact with the touch panel.

The scaling operation is an operation to scale an area of the document being displayed, and for example, is an operation (for example, pinch-out) to enlarge a display area by contacting the touch panel with two fingers at a state in which the two fingers are closed and then spreading the two fingers while contacting the touch panel, and an operation (for example, pinch-in) to reduce a display area by contacting the touch panel with two fingers at a state in which the two fingers are open and then narrowing the two fingers while contacting the touch panel.

On the other hand, the display non-change operation is an operation in which the user does not change the area of the displayed document while browsing the document displayed on the UI device 180, and mainly, is an operation that the user performs unconsciously.

In a case where the display non-change operation is performed, the document display processing unit 210 does not change the screen display of the UI device 180, but the fact that the display non-change operation is performed is accumulated in the history information.

In addition, in a case where the display non-change operation is performed, the document display processing unit 210 may control the UI device 180 to add a highlight at a position where the operation is performed. In this case, only the highlight is added, but the area itself of the document being displayed does not change.

Furthermore in this case, the document display processing unit 210 may control the UI device 180 to cause the highlight to be disappeared in a few seconds.

For example, the display non-change operation includes a tracing operation, a tap operation, and a press and hold operation. While the user reads a document, when an interest level and a concentration level of the user increase, such actions naturally occur, and the user himself or herself does not know why he or she has done the actions. The actions are like body language such as naturally moving a hand during a conversation.

The tracing operation is an operation to contact the vicinity of characters being displayed with a finger, a touch pen, or the like, and to move the finger, the touch pen, or the like in a reading direction, so as to facilitate a visual observation of the attention object when the user browses a document.

The document display processing unit 210 may control the UI device 180 to add, for example, a highlight of a line shape along a traced position in a case where the tracing operation is performed.

In addition, it is assumed that the tracing operation can be distinguished from the scroll operation. For example, in a case where the finger, the touch pen, or the like is in contact with the touch panel without being moved for a predetermined time, and thereafter it is moved, or in a case where the finger, the touch pen, or the like is moved slower than a predetermined speed, these motions are recognized as the tracing operation.

The tap operation is an operation to hit the touch panel with the finger, the touch pen, or the like, so as to facilitate recognition of the attention object, when the user browses a document.

In a case where the finger, the touch pen, or the like is in contact with the touch panel, is not moved while being in contact with the touch panel, and released from the touch panel within a predetermined time (for example, within a second), these motions are recognized as the tap operation.

The document display processing unit 210 may control the UI device 180 to add, for example, a highlight of a circle shape centered on the tapped position, in a case where the tap operation is performed.

The press and hold operation is an operation to press the touch panel with the finger, the touch pen, or the like so as to facilitate recognition of the attention object, when the user browses a document.

In a case where the finger, the touch pen, or the like is in contact with the touch panel, is not moved while being in contact with the touch panel, and the touch panel is pressed with the finger, the touch pen, or the like longer than a predetermined time (for example, a second), these motions are recognized as the press and hold operation.

The document display processing unit 210 may control the UI device 180 to add, for example, a highlight of a circle shape centered on the pressed and held position, in a case where the press and hold operation is performed.

The interest level calculation instruction unit 226 (FIG. 2) receives an instruction (calculation instruction) to calculate an interest level, for example, by the user operating the UI device 180.

When receiving the calculation instruction, the interest level calculation instruction unit 226 instructs the operation history extraction unit 230 and the interest level calculating unit 240 to perform processes, described later.

Here, the interest level will be described.

The term “interest level” is a quantitative index indicating which degree the user is attracted, which degree the user has an interest, and which degree the user is concentrated, when the user browses a document.

In other words, the interest level is an index indicating the level of interest of the user with respect to the document, or an index indicating the concentration level of the user with respect to the document. It is indicated that the higher the interest level is, the higher the interest of the user in the browsing object is, the user is concentrating on the browsing object.

Generally, in a case where the user is concentrating on browsing a document printed on a paper, the user tends to unconsciously contact an attention object by tracing or tapping characters.

Accordingly, even in a case where the user browses the document using the browsing device 2, when the user browses the document while performing the display non-change operation without a conscious to change a display state of the document, the interest level of the user with respect to the browsing object is high.

The calculation instruction includes a designation of a user or a document that is an object of the interest level.

For example, in a case where as the object of the interest level, the document A is designated, but a user is not designated, the calculation instruction indicates an instruction to calculate the interest level of respective users (users who have browsed the document A) with respect to the document A.

Further, for example, in a case where as the object of the interest level, the user A is designated but a document is not designated, the calculation instruction indicates an instruction to calculate the interest level of the user A with respect to respective documents (documents that have been browsed by the user A).

Further, for example, in a case where as the object of the interest level, the document A and the user A are designated, the calculation instruction indicates an instruction to calculate the interest level of the user A with respect to the document A.

Further, for example, in a case where there is no designation of a user and a document, the calculation instruction indicates an instruction to calculate the interest level of all users with respect to all documents.

Further, in a case where as the object of the interest level, the document A is designated, it may be selected whether or not to calculate the interest level of the user with respect to respective document configuration components configuring the document A.

Here, the document configuration components are objects configuring the document, and include for example, the break of document such as a first chapter and a second chapter, the break of page such as a first page and a second page, and the like, images and photos contained in the document.

In a case where a calculation of the interest level of the user with respect to respective document configuration components configuring the document A is selected, when, for example, the first chapter is designated as the document configuration component, the calculation instruction indicates an instruction to calculate the interest level of the user A with respect to the first chapter of the document A. On the other hand, when there is no designation of the document configuration component, the calculation instruction indicates an instruction to respectively calculate the interest level of the user A with respect to each chapter (first chapter, second chapter, and . . . ) of the document A.

In a case where there is an instruction to calculate the interest level of the user with respect to the document configuration component, the interest level calculation instruction unit 226 outputs an calculation instruction to the document configuration component determination unit 228.

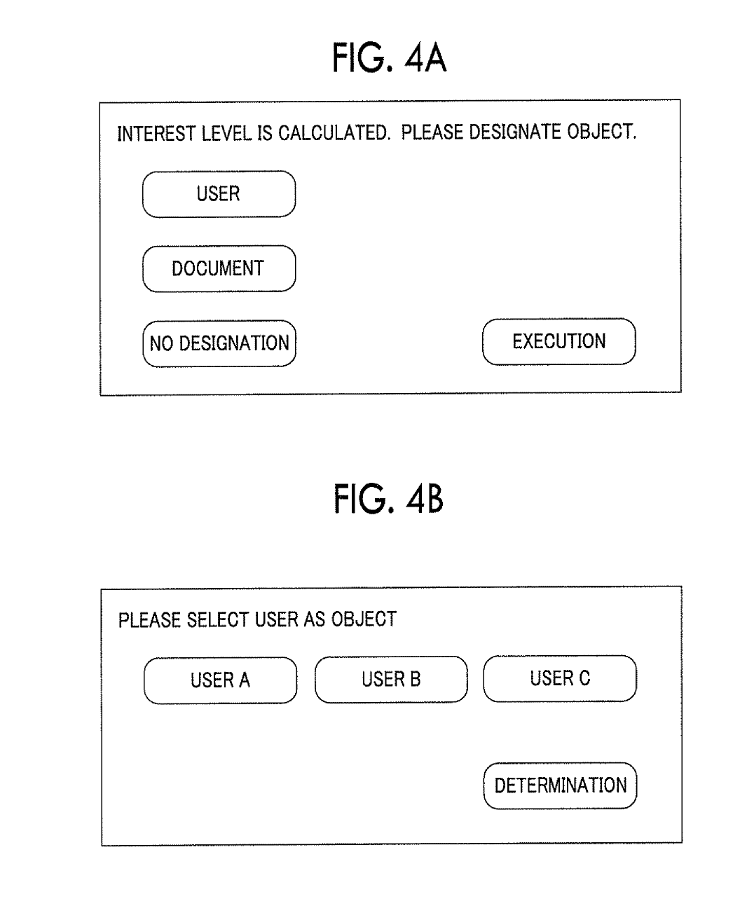

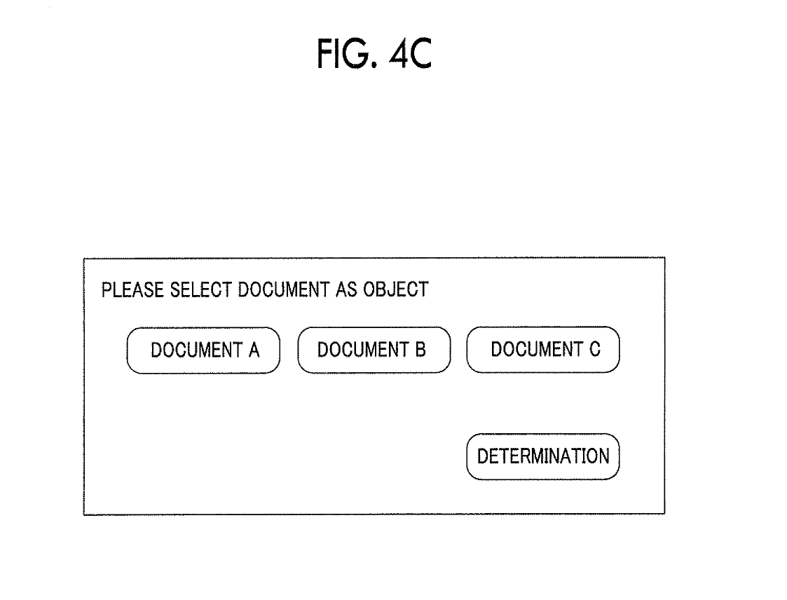

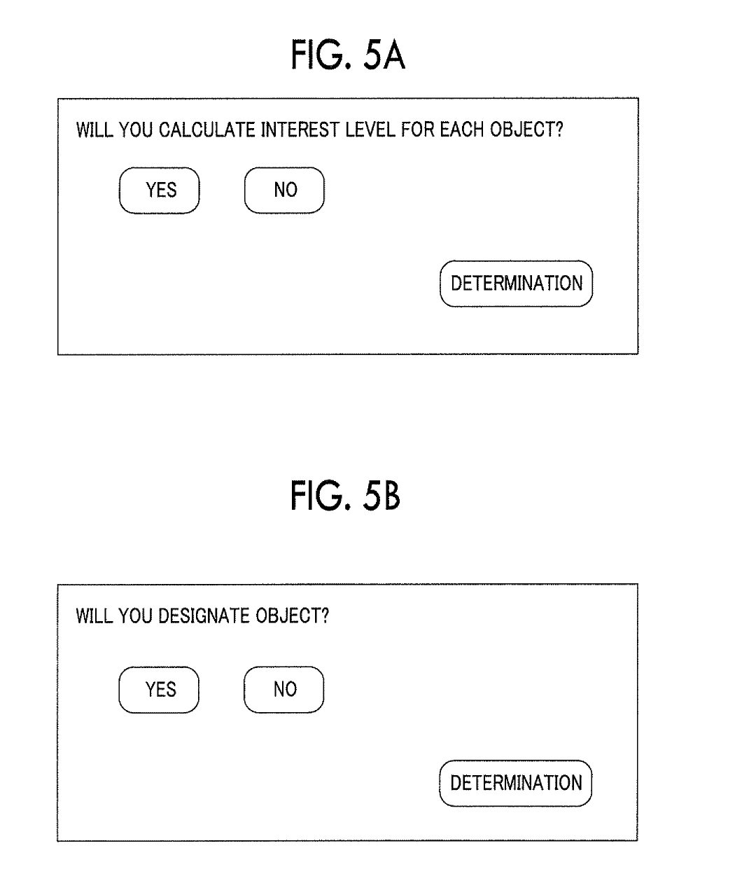

FIGS. 4A to 4C and FIGS. 5A and 5B are diagrams exemplifying operation screens displayed on the UI device 180 by the interest level calculation instruction unit 226.

First, the interest level calculation instruction unit 226 causes the operation screen exemplified in FIG. 4A to be displayed on the UI device 180.

If the user presses down (touches) “No designation” button and presses down “Execution” button, the interest level calculation instruction unit 226 receives a calculation instruction to calculate the interest levels of all users with respect to all documents.

Further, if the user presses down “User” button on the operation screen exemplified in FIG. 4A, the operation screen exemplified in FIG. 4B is displayed, whereas if the user presses down “User A” button and “Determination” button, the operation screen of FIG. 4A is displayed.

At this time, if the user presses down “Execution” button, the interest level calculation instruction unit 226 receives a calculation instruction to calculate the interest levels of the user A with respect to all documents that have been browsed by the user A.

In addition, it is possible for the user to press down plural buttons (for example, “User A” button and “User B” button) on the operation screen exemplified in FIG. 4B, if plural buttons are pressed down, the interest level calculation instruction unit 226 receives a calculation instruction to calculate the interest levels of the corresponding respective users.

Further, if the user presses down “Document” button on the operation screen exemplified in FIG. 4A, the operation screen exemplified in FIG. 4C is displayed, whereas if the user presses down “Document A” button and “Determination” button, the operation screen of FIG. 4A is displayed.

At this time, if the user presses down “Execution” button, the interest level calculation instruction unit 226 receives a calculation instruction to calculate the interest levels of respective users with respect to Document A.

In addition, it is possible for the user to press down plural buttons (for example, “Document A” button and “Document B” button) on the operation screen exemplified in FIG. 4C, if plural buttons are pressed down, the interest level calculation instruction unit 226 receives a calculation instruction to calculate the interest levels of the users with respect to corresponding respective documents.

On the other hand, in a case where the user presses down “User A” button and “Determination” button on the operation screen exemplified in FIG. 4B, and the user presses down “Document” button on the operation screen of FIG. 4A, the operation screen of FIG. 4C is displayed.

At this time, if the user presses down “Document A” button and “Determination” button, and the user presses down “Execution” button on the operation screen of FIG. 4A, the interest level calculation instruction unit 226 receives a calculation instruction to calculate the interest level of the user A with respect to document A.

Further, in a case where one document is selected on the operation screen of FIG. 4C (for example, “Document A” button is pressed down), the operation screen exemplified in FIG. 5A may be displayed.

At this time, if the user presses down “No” button and “Determination” button, and the user presses down “Execution” button on the operation screen of FIG. 4A, as described above, the interest level calculation instruction unit 226 receives a calculation instruction to calculate the interest levels of the users with respect to document A.

On the other hand, on the operation screen of FIG. 5A, the user presses down “Yes” button and “Determination” button, the operation screen exemplified in FIG. 5B is displayed.

At this time, the user presses down “No” button and “Determination” button, and the user presses down “Execution” button on the operation screen of FIG. 4A, the interest level calculation instruction unit 226 receives a calculation instruction to calculate respective interest levels of the user with respect to respective chapters (first chapter, second chapter, and the like) of the document A.

Further, if the user presses down “Yes” button and “Determination” button on the operation screen of FIG. 5B, the operation screen (not shown) for designating a document configuration component (object) is displayed.

If the user designates a document configuration component (for example, “first chapter”) using the operation screen, and the user presses down “Execution” button on the operation screen illustrated in FIG. 4A, the interest level calculation instruction unit 226 receives a calculation instruction to calculate the interest level of the user with respect to the first chapter of document A.

In addition, although it is assumed that buttons are pressed down in a case of designating an object, or the like in FIGS. 4A to 4C and FIGS. 5A and 5B, the object may be designated by inputting characters (for example, “the user A” is input).

The document configuration component determination unit 228 (FIG. 2) acquires document data that is a calculation object of an interest level, determines a document configuration component configuring the document and a range of the document configuration component in the document, and generates document configuration component information (will be described later using FIG. 3C).

Specifically, the document configuration component determination unit 228 analyzes document data, determines a document configuration component included in the document, and a start position and an end position of the document configuration component.

For example, in a case where information indicating a page is included in the document data, the range indicating the page is indicated in the document data.

Further, for example, in a case where a character string of “first chapter” is included in the document, the document configuration component determination unit 228 determines that the document configuration component “first chapter” is started from the character string.

Then, in a case where a character string “second chapter” is searched, the document configuration component determination unit 228 determines that the document configuration component “first chapter” is ended at the character string immediately before character string.

Further, for example, in a case where there is no character string, but arranged pixels in the document data, the document configuration component determination unit 228 determines the arrangement of pixels as an image, and respectively determines the coordinate corresponding to an upper left position as a start position and the coordinate corresponding to an lower right position as a start position. The range of an image of a rectangular shape is specified by determining the upper left position and the lower right position of the image.

In addition, in a case where there is a designation (for example, a designation of “the first chapter”) of the document configuration component, the document configuration component determination unit 228 may determine only the designated document configuration component.

Further, the document configuration component determination unit 228 outputs the generated document configuration component information to the interest level calculating unit 240.

FIG. 3C is a diagram exemplifying document configuration component information.

The document configuration component information includes document identification information, document configuration component identification information for identifying the document configuration component, and document configuration component range information indicating a range (position) of the document configuration component.

In a case where the document is broken into pages, the document configuration component range information may include page numbers.

For example, in a case where the document configuration component is a break of document of a first chapter and a second chapter, the document configuration component range information of the document configuration component “first chapter” includes a start position coordinate and an end position coordinate of the first chapter.

Further, for example, in a case where the document configuration component is an image, document configuration component range information of the document configuration component “image A” includes a coordinate of an upper left position and a coordinate of a lower right position of the image A.

Based on the calculation instruction, the display non-change operation history extraction unit 232 (FIG. 2) of the operation history extraction unit 230 extracts history information, on which the display non-change operation is performed, from the history information storage unit 222, generates an operation history (display non-change operation history) and outputs the generated operation history to the interest level calculating unit 240.

Based on the calculation instruction, the display change operation history extraction unit 234 of the operation history extraction unit 230 extracts history information, on which the display non-change operation is performed, from the history information storage unit 222, generates an operation history (display change operation history), and outputs the generated operation history to the interest level calculating unit 240.

For example, in a case where there is a designation to calculate the interest level of the user A with respect to the document A, the display non-change operation history extraction unit 232 extracts history information including the identification information of the user A, the identification information of the document A, and operation information indicating the display non-change operation from the history information storage unit 222, and generates the display non-change operation history.

At this time, the display change operation history extraction unit 234 extracts history information including the identification information of the user A, the identification information of the document A, and the operation information indicating the display change operation from the history information storage unit 222, and generates the display change operation history.

Further, for example, in a case where there is a designation to calculate the interest level of the user A (a document is not designated), the display non-change operation history extraction unit 232 extracts history information including the identification information of the user A and the operation information indicating the display non-change operation from the history information storage unit 222, and generates the display non-change operation history.

At this time, the display change operation history extraction unit 234 extracts history information including the identification information of the user A and the operation information indicating the display change operation from the history information storage unit 222, and generates the display change operation history.

FIG. 3D is a diagram exemplifying an operation history.

The operation history includes operation information, operation position information, duration of the corresponding operation, document identification information, document position information, and user identification information.

In a case where the operation history is a display non-change operation history, the operation information indicates the display non-change operation (for example, the tracing operation) exemplified in FIG. 3B, and in a case where the operation history is a display change operation history, the operation information indicates the display change operation (for example, the scroll operation) exemplified in FIG. 3B.

Further, the duration includes a start time and an end time of an operation, and the duration is a time obtained by subtracting the start time from the end time.

In addition, the start time of the operation is a time when the finger, the touch pen, or the like comes into contact with the touch panel, and the end time of the operation is a time when the finger, the touch pen, or the like is released from the touch panel (however, in a case of the press and hold operation, the end time may be a time when the press and hold operation is recognized).

The interest level calculating unit 240 (FIG. 2) calculates an interest level based on at least display non-change operation history.

For example, in a case where the calculation instruction is an instruction to calculate the interest level of the user A with respect to the document A, the interest level calculating unit 240 calculates the interest level of the user A with respect to the document A.

On the other hand, for example, in a case where the calculation instruction is an instruction to calculate the interest level of the user A (a document is not designated), the interest level calculating unit 240 calculates the interest level of the user A with respect to the document A, and calculates the interest level of the user A with respect to the document B.

On the other hand, for example, in a case where the calculation instruction is an instruction to calculate the interest level of respective users with respect to the document A (a user is not designated), the interest level calculating unit 240 calculates the interest level of the user A with respect to the document A, and calculates the interest level of the user B with respect to the document A.

The interest level calculating unit 240 calculates the interest level using, for example, following equation (1).

[Interest level]=C1+C2×[appearance degree of display non-change operation],[appearance degree of display non-change operation]=C3×[number of occurrences of display non-change operation]C4×[sum of durations of display non-change operation] (1)

Here, C1 to C4 are integers, and C1, C3, and C4 may be 0.

For example, in a case where there is a designation to calculate the interest level of the user A with respect to the document A, the interest level calculating unit 240 calculates the number of occurrences of the display non-change operation and the sum of durations of the display non-change operation when the user A browses the document A, from the received display non-change operation history.

Then, the interest level calculating unit 240 calculates the equation (1) using the number of occurrences of the display non-change operation and the sum of durations of the display non-change operation that are calculated, and calculates the interest level of the user A with respect to the document A.

Further, for example, in a case where there is a designation to calculate the interest level of the user A without a document not being designated, the interest level calculating unit 240 searches documents that the user A has browsed, from the received display non-change operation history.

For example, in a case where the user A has browsed the document A and the document B, the interest level calculating unit 240 calculates the number of occurrences of the display non-change operation and the sum of durations of the display non-change operation when the user A browses the document A.

Then, the interest level calculating unit 240 calculates the equation (1) using the number of occurrences of the display non-change operation and the sum of durations of the display non-change operation that are calculated, and calculates the interest level of the user A with respect to the document A.

In the same manner, the interest level calculating unit 240 calculates the equation (1) by calculating the number of occurrences of the display non-change operation and the sum of durations of the display non-change operation when the user A browses the document B and then calculates the interest level of the user A with respect to the document B.

Further, for example, in a case where there is a designation to calculate the interest level with respect to the document A without a user not being designated, the interest level calculating unit 240 searches users who have browsed the document A from the received display non-change operation history.

For example, in a case where the user A and the user B have browsed the document A, the interest level calculating unit 240 calculates the number of occurrences of the display non-change operation and the sum of durations of the display non-change operation when the user A browses the document A.

Then, the interest level calculating unit 240 calculates the equation (1) using the number of occurrences of the display non-change operation and the sum of durations of the display non-change operation that are calculated, and calculates the interest level of the user A with respect to the document A.

In the same manner, the interest level calculating unit 240 calculates the equation (1) by calculating the number of occurrences of the display non-change operation and the sum of durations of the display non-change operation when the user B browses the document A and then calculates the interest level of the user B with respect to the document A.

Further, for example, in a case where there is a designation to calculate the interest level of the user A with respect to the first chapter of the document A, the interest level calculating unit 240 acquires range information of the document configuration component “first chapter”, from the document configuration component information of the document A that is received from the document configuration component determination unit 228.

Further, the interest level calculating unit 240 extracts display non-change operation history including operation position information included in the range of the document configuration component “first chapter”, from the display non-change operation history of the user A with respect to the document A.

For example, in a case where the user A performs a “tracing operation” in a certain position of the “first chapter”, the display non-change operation history corresponding to the operation is extracted.

Then, the interest level calculating unit 240 calculates the equation (1) by calculating the number of occurrences of the display non-change operation and the sum of durations of the display non-change operation when the user A browses the document configuration component “first chapter” of the document A, and then calculates the interest level of the user A with respect to the first chapter of the document A.

Further, for example, in a case where there is a designation to calculate the interest level of the user A with respect to the first page of the document A, the interest level calculating unit 240 extracts the display non-change operation history including the operation position information including information indicating the first page, from the display non-change operation history of the user A with respect to the document A.

For example, in a case where the user A performs a “tap operation” in a certain position of the “first page”, the display non-change operation history corresponding to the operation is extracted.

Then, interest level calculating unit 240 calculates the equation (1) by calculating the number of occurrences of display non-change operation and the sum of durations of display non-change operation when the user A browses the document configuration component “first page” of the document A, and then calculates the interest level of the user A with respect to the first page of the document A.

Further, the interest level calculating unit 240 may calculate the interest level using the following equation (2).

[Interest level]=C1+C2×[appearance degree of display non-change operation]/[document amount] (2)

Here, the document amount is a value indicating a volume of a document that is a calculation object of the interest level, for example, a document data amount, an area of the document, the number of characters of the document, or the like.

Further, the interest level calculating unit 240 may calculate the interest level using the following equation (3).

[Interest level]=C1+C2×[appearance degree of display non-change operation]+C5×[appearance degree of display change operation]

[Appearance degree of display change operation]=C6×[number of occurrences of display change operation]+C7×[sum of durations of display change operation] (3)

Here, C5 to C7 are integers, and respectively may be 0.

Further, it is established that C2>C5. That is, it is set that the contribution degree of the appearance degree of the display non-change operation is larger than the contribution degree of the appearance degree of the display change operation.

Further, the interest level calculating unit 240 may calculate the interest level using the following equation (4).

[Interest level]=C1+C8×[appearance degree of display non-change operation]̂2+C9×[appearance degree of display change operation] (4)

Here, C8 and C9 are integers, and C9 may be 0.

Further, it is established that [appearance degree of display non-change operation]>1. That is, it is set that the contribution degree of the appearance degree of the display non-change operation is larger than the contribution degree of the appearance degree of the display change operation.

The interest level display unit 244 performs a process of causing the interest level calculated by the interest level calculating unit 240 to be displayed on the UI device 180.

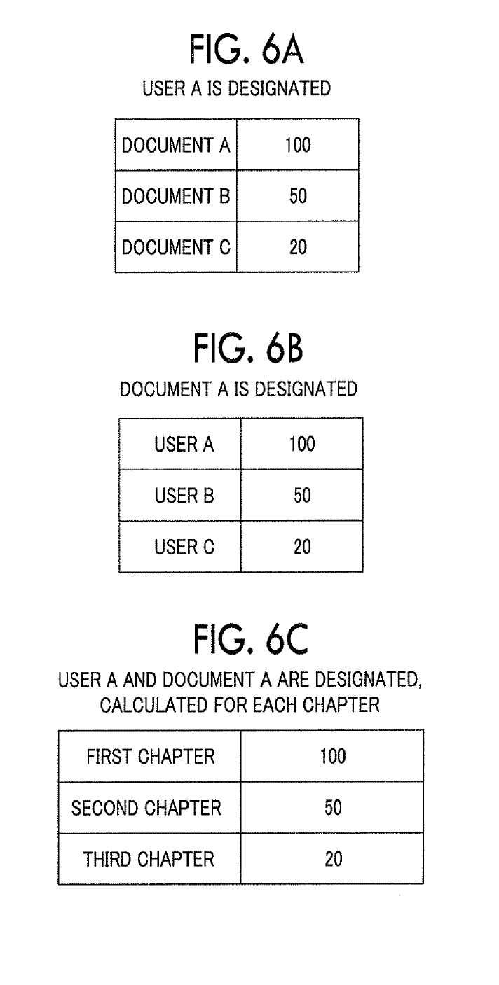

FIGS. 6A to 6C are diagrams exemplifying the interest level displayed on the UI device 180 by the interest level display unit 244.

FIG. 6A exemplifies the interest level in a case where the user A is designated and a document is not designated.

As exemplified in FIG. 6A, the interest level of the user A with respect to the document A is indicated as 100, the interest level of the user A with respect to the document B is indicated as 50, and the interest level of the user A with respect to the document C is indicated as 20.

Accordingly, it becomes clear that the user A has the highest interest level with respect to the document A.

FIG. 6B exemplifies the interest level in a case where the document A is designated and a user is not designated.

As exemplified in FIG. 6B, the interest level of the user A with respect to the document A is indicated as 100, the interest level of the user B with respect to the document A is indicated as 50, and the interest level of the user C with respect to the document A is indicated as 20.

Accordingly, it becomes clear that the person who has the highest interest level with respect to the document A is the user A.

FIG. 6C exemplifies the interest level calculated for each document configuration component, in a case where the user A and the document A are designated.

As exemplified in FIG. 6C, the interest level of the user A with respect to the first chapter of the document A is indicated as 100, the interest level with respect to the second chapter is indicated as 50, and the interest level with respect to the third chapter is indicated as 20.

Accordingly, it becomes clear that the user A has the highest interest level with respect to the first chapter of the document A.

### Second Exemplary Embodiment

Next, a second exemplary embodiment will be described.

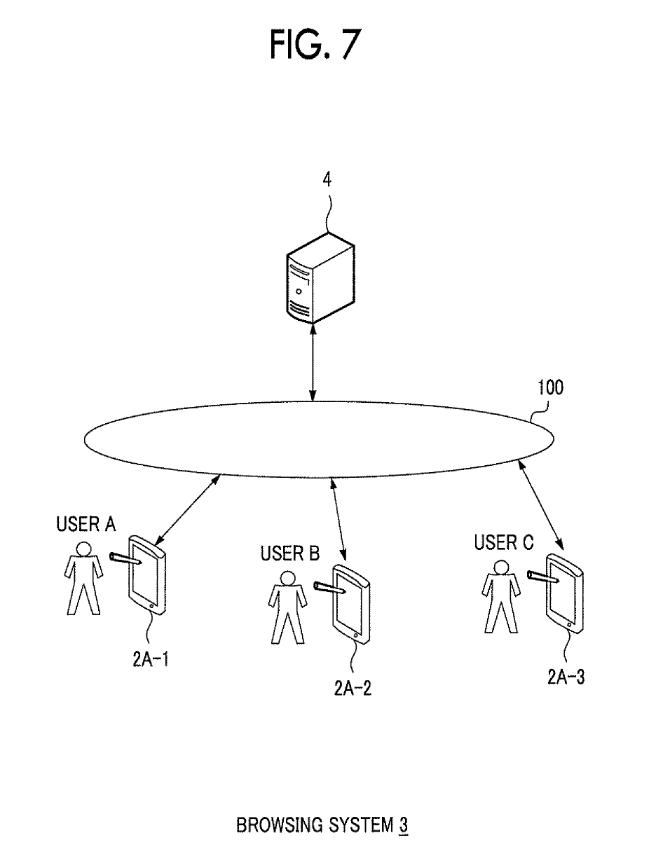

FIG. 7 is a diagram illustrating a browsing system 3 according to the second exemplary embodiment.

As illustrated in FIG. 7, the browsing system 3 is configured by browsing devices 2A-1 to 2A-3 and a browsing history management device 4 that are connected through a network 100 such as an internet or a Local Area Network (LAN).

In addition, hereinafter, when the plural configuration components such as the browsing devices 2A-1 to 2A-3 are indicated without specifying a certain browsing device, in some cases, the browsing devices 2A-1 to 2A-3 are simply abbreviated as a browsing device 2A, or the like.

Further, although three browsing devices 2A are used in the present exemplary embodiment, the number thereof may be two or less, or four or more.

The browsing device 2A performs a process of allowing the user to browse a document.

The browsing history management device 4 calculates an interest level from a browsing history.

The browsing device 2A and the browsing history management device 4, as described above, have a hardware configuration illustrated in FIG. 1.

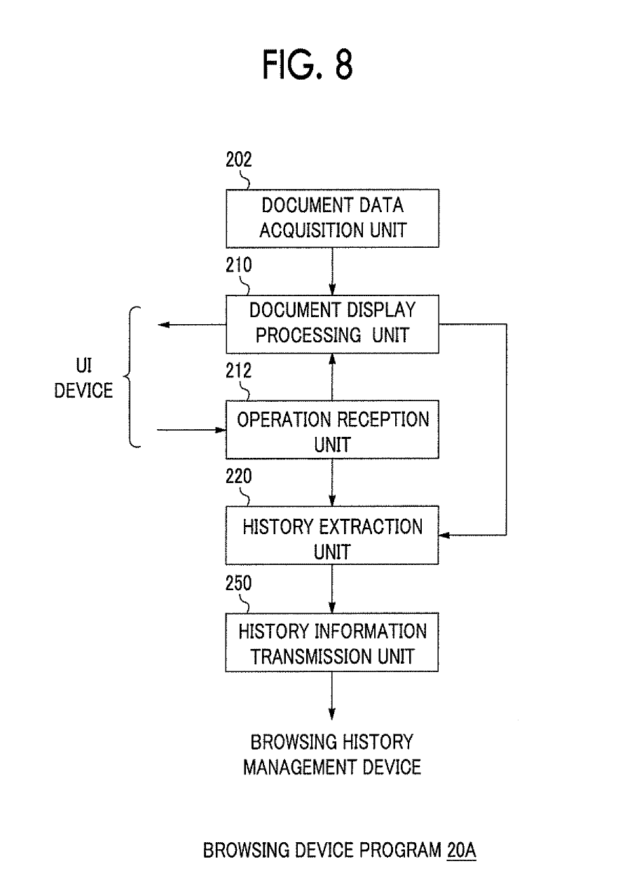

FIG. 8 is a block diagram illustrating a browsing program 20A executed in the browsing device 2A according to the second exemplary embodiment.

As illustrated in FIG. 8, the browsing program 20A is configured by a document data acquisition unit 202, a document display processing unit 210, an operation reception unit 212, a history extraction unit 220, and a history information transmission unit 250.

The history information transmission unit 250 transmits history information extracted by the history extraction unit 220 to the browsing history management device 4.

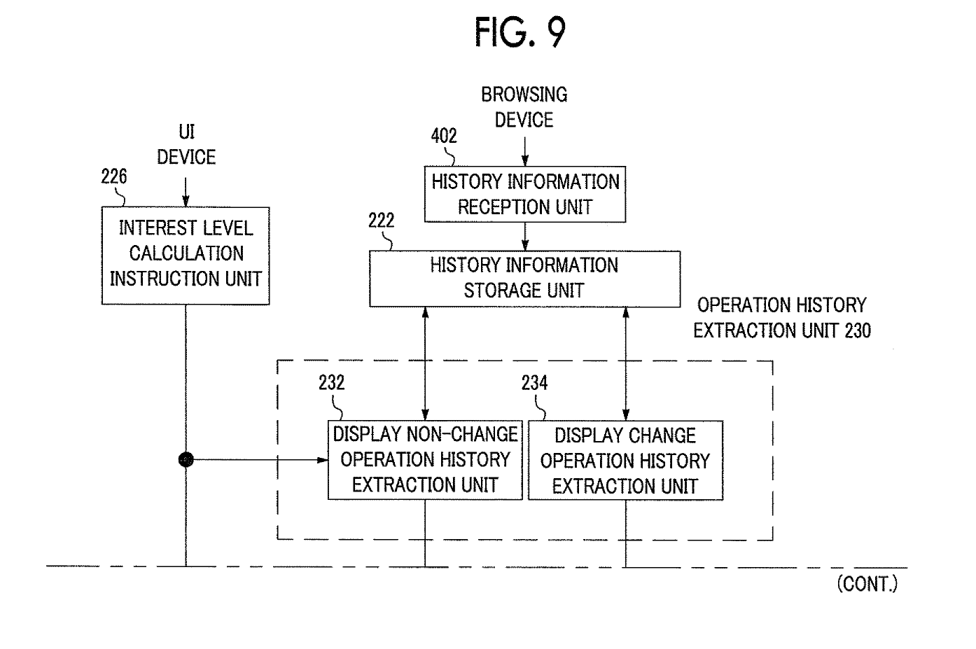

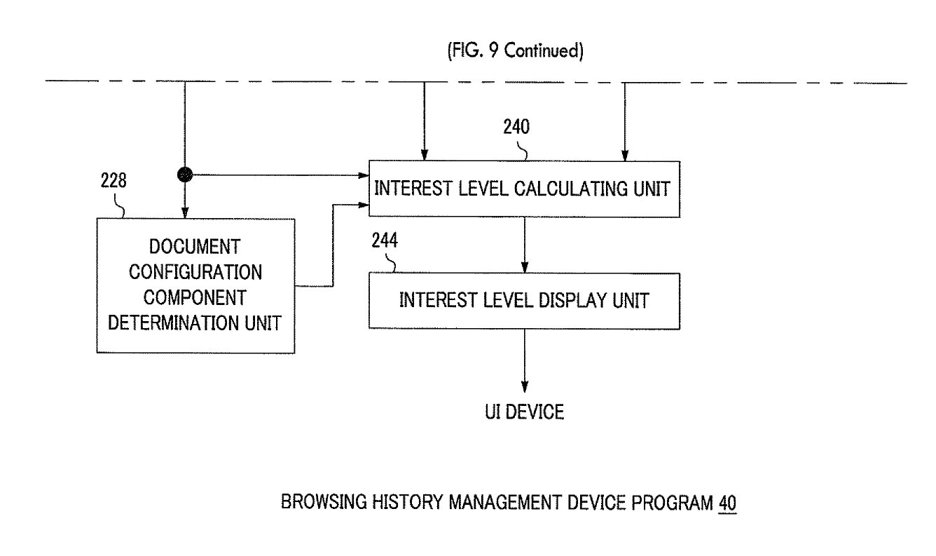

FIG. 9 is a block diagram illustrating a browsing history management device program 40 executed in the browsing history management device 4 according to the second exemplary embodiment.

As illustrated in FIG. 9, the browsing history management device program 40 is configured by a history information reception unit 402, a history information storage unit 222, an interest level calculation instruction unit 226, a document configuration component determination unit 228, an operation history extraction unit 230, an interest level calculating unit 240, and an interest level display unit 244.

The history information reception unit 402 receives history information from the browsing device 2A and stores the received history information in the history information storage unit 222.

In addition, the interest level display unit 244 may display an interest level on the UI device 180 of the browsing history management device 4, and may display an interest level on the UI device 180 of the browsing device 2A.

Further, each configuration component illustrated in FIGS. 8 and 9 may be respectively located in any position of the browsing program 20A or the browsing history management device program 40.

Each configuration component illustrated in FIGS. 8 and 9 may be respectively provided in a separate device other than the browsing device 2A or the browsing history management device 4.

### Modification Example

Although the document configuration component determination unit 228 generates the document configuration component information in the aforementioned exemplary embodiment, the document configuration component information may be included in the history information.

Although the interest level is calculated in a case of being instructed by the interest level calculation instruction unit 226 in the aforementioned exemplary embodiment, the interest level may be calculated at each time when the history information is newly extracted.

Further, although the interest level with respect to each document is calculated, in a case where only a user is designated but a document is not designated in the designation performed by the interest level calculation instruction unit 226, in the aforementioned exemplary embodiment, the interest level with respect to all documents may be calculated without classifying all documents into each document.

At this time, the interest level of the user with respect to documents in general is calculated, and for example, the interest level of the user with respect to reading is calculated, regardless of a type of document.

Although the browsing device 2 performs a calculation and a display of the interest level in the aforementioned exemplary embodiment, if the browsing device 2 calculates the interest level by the interest level calculating unit, the calculated interest level may be transmitted to a server, not shown, through the communication device 170. Further, the browsing device 2 may transmit the history extracted by the history extraction unit 220 to the server (not shown) through the communication device 170, and the server may calculate the interest level. The server may record a calculation result of the interest level with respect to a certain document as attribute information (meta-information) of original document data, aggregate the information in the server, and then use it for searching a document.

Further, although the UI device 180 is mainly a touch panel in the aforementioned exemplary embodiment, in a case where the browsing device 2 is a PC, the UI device 180 may be a screen such as a Liquid Crystal Display (LCD) display device or a Cathode Ray Tube (CRT) display device, a keyboard or a mouse.

In this case, an operation to move or to drag a pointer along characters with the mouse may be set to “display non-change operation”.

At this time, the operation position information corresponds to a position of the pointer in the document displayed on the screen.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A browsing device comprising:
a display unit that displays a content;
an operation receiving unit that receives a user's operation;
a history extraction unit that extracts an operation history regarding an operation that does not change the display of the content displayed on the display unit; and
a calculation unit that calculates an interest level of the user with respect to the content, based on the operation history extracted by the history extraction unit.

2. The browsing device according to claim 1,
wherein the calculation unit calculates the interest level of the user with respect to the content, based on at least one of the number of occurrences of the operation that does not change the display of the content and a duration of the operation that does not change the display of the content.

3. The browsing device according to claim 1,
wherein the history extraction unit associates the operation that does not change the display of the content with a position on the content related to the operation that does not change the display of the content, and extracts the operation history.

4. The browsing device according to claim 2,
wherein the history extraction unit associates the operation that does not change the display of the content with a position on the content related to the operation that does not change the display of the content, and extracts the operation history.

5. The browsing device according to claim 3,
wherein the calculation unit calculates the interest level with respect to a document configuration component corresponding to the position on the content related to the operation that does not change the display of the content.

6. The browsing device according to claim 4,
wherein the calculation unit calculates the interest level with respect to a document configuration component corresponding to the position on the content related to the operation that does not change the display of the content.

7. The browsing device according to claim 1,
wherein the history extraction unit extracts a first operation history regarding the operation that does not change the display of the content displayed on the display unit and a second operation history regarding the operation that changes the display of the content displayed on the display unit, and
wherein the calculation unit calculates the interest level of the user with respect to the content, based on the first operation history and the second operation history.

8. The browsing device according to claim 2,
wherein the history extraction unit extracts a first operation history regarding the operation that does not change the display of the content displayed on the display unit and a second operation history regarding the operation that changes the display of the content displayed on the display unit, and
wherein the calculation unit calculates the interest level of the user with respect to the content, based on the first operation history and the second operation history.

9. The browsing device according to claim 3,
wherein the history extraction unit extracts a first operation history regarding the operation that does not change the display of the content displayed on the display unit and a second operation history regarding the operation that changes the display of the content displayed on the display unit, and
wherein the calculation unit calculates the interest level of the user with respect to the content, based on the first operation history and the second operation history.

10. The browsing device according to claim 4,
wherein the history extraction unit extracts a first operation history regarding the operation that does not change the display of the content displayed on the display unit and a second operation history regarding the operation that changes the display of the content displayed on the display unit, and
wherein the calculation unit calculates the interest level of the user with respect to the content, based on the first operation history and the second operation history.

11. The browsing device according to claim 5,
wherein the history extraction unit extracts a first operation history regarding the operation that does not change the display of the content displayed on the display unit and a second operation history regarding the operation that changes the display of the content displayed on the display unit, and
wherein the calculation unit calculates the interest level of the user with respect to the content, based on the first operation history and the second operation history.

12. The browsing device according to claim 6,
wherein the history extraction unit extracts a first operation history regarding the operation that does not change the display of the content displayed on the display unit and a second operation history regarding the operation that changes the display of the content displayed on the display unit, and
wherein the calculation unit calculates the interest level of the user with respect to the content, based on the first operation history and the second operation history.

13. The browsing device according to claim 1,
wherein when the operation receiving unit receives the operation that does not change the display of the content, the display unit adds a display corresponding to the operation at a position corresponding to the operation.

14. The browsing device according to claim 2,
wherein when the operation receiving unit receives the operation that does not change the display of the content, the display unit adds a display corresponding to the operation at a position corresponding to the operation.

15. The browsing device according to claim 3,
wherein when the operation receiving unit receives the operation that does not change the display of the content, the display unit adds a display corresponding to the operation at a position corresponding to the operation.

16. The browsing device according to claim 4,
wherein when the operation receiving unit receives the operation that does not change the display of the content, the display unit adds a display corresponding to the operation at a position corresponding to the operation.

17. A browsing system comprising:
a browsing device that enables a user to browse a content; and
a management device that manages a user's browsing history of the content,
wherein the browsing device includes:
a display unit that displays the content; and
an operation receiving unit that receives a user's operation, and
wherein the management device includes:
a history extraction unit that extracts an operation history regarding an operation that does not change a display of the content displayed on the display unit; and
a calculation unit that calculates an interest level of the user with respect to the content, based on the operation history regarding the operation that does not change the display of the content that is extracted by the history extraction unit.

18. A non-transitory computer readable medium storing a program causing a computer to execute:
extracting an operation history regarding an operation that does not change a display of a content displayed on a display device; and
calculating an interest level of a user with respect to the content, based on the operation history regarding the operation that does not change the display of the content that is extracted in the extracting.
